(19) United States
(12) Patent Application Publication
(10) Pub. No.: US 2010/0175426 A1
(43) Pub. Date: Jul. 15, 2010

(54) Power Management For Gasification Facility

(75) Inventor: Paul Steven Wallace, Katy, TX (US)

Correspondence Address: KING & SPALDING, LLP, 1100 LOUISIANA ST., STE. 4000, ATTN.: IP Docketing, HOUSTON, TX, 77002-5213, US

(73) Assignee: Hunton Energy Holdings, LLC, Houston, TX (US)

(21) Appl. No.: 12/351,515

(22) Filed: Jan. 9, 2009

(51) Int. Cl. F25J 3/00; G06F 1/26

(52) U.S. Cl. 62/646; 700/287

(57) ABSTRACT

Systems and methods for controlling power needs of a gasification facility are described. The systems include an ice refrigeration storage unit for supplying refrigeration to the larger consumers of cooling in the gasification facility. The methods include manipulating the ice refrigeration storage unit to minimize the utilization of power during peak price periods and maximize the utilization of power during offpeak price periods.

### CROSS REFERENCE TO RELATED APPLICATIONS

The present application is related to U.S. patent application Ser. No. ______, entitled “Low Water Consumption Cooling Tower for Gasification Plants” and filed on ______, 2009, and U.S. Provisional Patent Application No. 61/084,070, entitled “Zero Discharge Waste Water System for Gasification Plants” and filed on Jul. 28, 2008, which are all assigned to the assignee of the present application. Each of these related applications are incorporated by reference in its entirety herein.

### TECHNICAL FIELD

The application relates generally to power management for gasification facilities. More particularly, the application relates to the management of electrical loads for gasification processes, such as for the production of substitute natural gas (SNG) from fossil fuels, to maximize the export of power during peak price periods, and minimize the export of power during offpeak price periods. In facilities that do not produce power, the import of power during peak price periods is minimized and the import of power during offpeak price periods is maximized.

### BACKGROUND

Gasification is a process that enables the conversion of fossil fuels, such as coal or petroleum coke, into SNG, hydrogen, or chemical feedstock. A number of processes in a gasification unit require large amounts of power or refrigeration. Currently, gasification facilities are operated under constant conditions and produce a constant amount of byproduct power, or baseload power. Recent increases in power prices during peak usage periods have resulted in less than optimum power production for current gasification facilities.

Accordingly, a need exists in the art for an improved system for power management of a gasification unit for SNG production.

### SUMMARY

The present invention satisfies the above-described need by providing systems and methods for controlling the power needs of a gasification facility.

Gasification systems of the present invention include a gasification unit and a refrigeration storage system having a cooled medium, such as ice water, for providing refrigeration to the gasification unit. The gasification unit may be a gasification unit for SNG production and can include a gasifier, an air separation unit, an acid gas removal system, a CO₂ refrigeration system, or any combination thereof. In certain embodiments, the gasification unit includes three air separation units operating at 40% capacity and having liquid oxygen storage for additional refrigeration.

Methods of the present invention include manipulating the gasification systems of the present invention to maximize the export of power during peak price periods and minimize the export of power during offpeak price periods. In certain embodiments, methods include utilizing the refrigeration storage system to produce and store the cooled medium during offpeak price periods when power demands are low, and then using the cooled medium for supplying refrigeration to the gasification unit during peak price periods when the market price of power is high. In certain embodiments, power can be imported for utilization during offpeak price periods when the market price of power is low. The power generated during offpeak price periods also can be exported during peak price periods. As a result, significant power revenue can be generated by the gasification systems of the present invention.

These and other aspects, features and embodiments of the present invention will become apparent to those skilled in the art upon consideration of the following detailed description of illustrated embodiments exemplifying the best mode for carrying out the invention as presently perceived.

### BRIEF DESCRIPTION OF THE DRAWINGS

FIG. 1 is a graph illustrating wholesale power pricing vs. time of day for a single day in and around Houston, Tex., in June 2008.

FIG. 2 illustrates an exemplary embodiment of a gasification unit for SNG production.

FIG. 3 illustrates an exemplary embodiment of an ice refrigeration system for supplying power to the gasification unit for SNG production of FIG. 2.

FIG. 4 is a graph comparing the power usage of existing baseload operations with the power usage of the load management system utilizing the ice refrigeration system of FIG. 3 in accordance with an exemplary embodiment.

The drawings illustrate only exemplary embodiments of the invention and are therefore not to be considered limiting of its scope, as the invention may admit to other equally effective embodiments.

### BRIEF DESCRIPTION OF EXEMPLARY EMBODIMENTS

The application is directed to systems and methods for controlling the power needs of a gasification unit. In particular, the application is directed to manipulating an ice refrigeration storage system to control the electrical loads for the larger consumers of cooling in the gasification unit. The ice refrigeration storage system allows gasification facilities to maximize the export of power during peak price periods, minimize the export of power during offpeak price periods, control the export of power during mid-peak price periods, and supply power during emergency peak periods. In facilities that do not produce power, the import of power during peak price periods is minimized and the import of power during offpeak price periods is maximized. As used herein, the term “peak price period” refers to a time period, typically mid-day, during which power demand is at a maximum and the market price of the power is at a premium. As used herein, the term “offpeak price period” refers to a time period, typically night, during which power demand is at a minimum and the market price of the power is the lowest. As used herein, the term “mid-peak price period” refers to time periods, typically morning and evening, between the peak and offpeak price periods. As used herein, the term “emergency peak period” refers to a time period, typically 1-2 hours, during impending blackout conditions.

The invention may be better understood by reading the following description of non-limiting, exemplary embodiments with reference to the attached drawings, wherein like parts of each of the figures are identified by the same reference characters, and which are briefly described as follows.

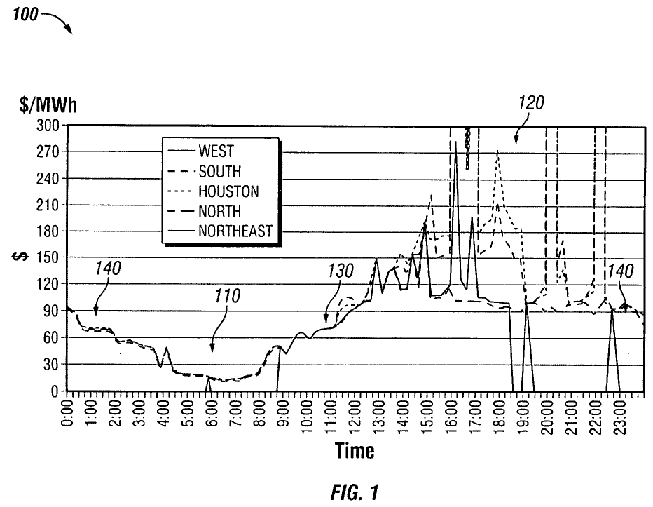

FIG. 1 is a graph 100 illustrating an exemplary embodiment of wholesale power pricing in and around Houston, Tex., USA, for a single day in June, 2008. The graph 100 shows the price per megawatt hour (MWh) vs. time of day. The power pricing is at a minimum during offpeak price period 110. The minimum price for power during the day is about $13/MWh. The offpeak price period 110 typically occurs between about 2:00 a.m. and about 10:00 a.m. The power pricing is at a maximum during peak price period 120. The maximum price for power during the day is about $3227/MWh. The peak price period 120 typically occurs between about 2:00 p.m. and about 10:00 p.m. Mid-peak price period 130 occurs between about 10:00 a.m. and about 2:00 p.m. and mid-peak price period 140 occurs between about 10:00 p.m. and about 2:00 a.m.

In certain alternative embodiments, the offpeak price period 110 begins at about 12:00 a.m. and ends at about 7:00 a.m. or begins at about 1:00 a.m. and ends at about 9:00 a.m. In certain alternative embodiments, the peak price period 120 begins at about 10:00 a.m. and ends at about 6:00 p.m. In certain alternative embodiments, the mid-peak price period 130 begins at about 7:00 a.m. and ends at about 10:00 a.m. In certain alternative embodiments, the mid-peak price period 140 begins at 6:00 p.m. and ends at 12:00 a.m. One having ordinary skill in the art can determine the offpeak, peak, and mid-peak price periods of a given day based on the power needs of a supplied area. Thus, these time periods may vary depending upon area location and demand requirements.

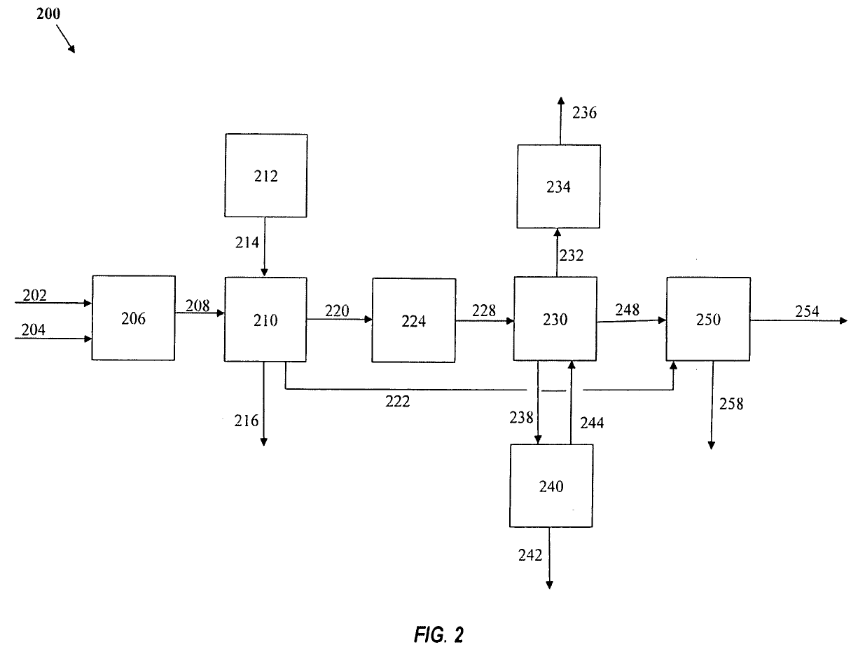

Referring to FIG. 2, an exemplary embodiment of a gasification unit 200 for SNG production is shown. The gasification unit 200 comprises a coke feed stream 202 at about 9,500 tons per day (TPD) and a biomass feed stream 204 at about 500 TPD. The coke feed stream 202 and biomass feed stream 204 enter slurry preparation units 206 (5 units at 25% capacity, or 5×25%) and produce a slurry stream 208. The slurry stream 208 can be formed by grinding or any other means known to one having ordinary skill in the art.

In alternative embodiments, the coke feed stream 202 and the biomass feed stream 204 may be replaced with other suitable feed streams, such as hazardous waste, hydrocarbon streams, carbohydrate-based compounds, coal, and municipal waste.

The slurry stream 208 enters gasifiers 210 (4×30%). Air separation units 212 (3×40% or 2×60%) also provide an oxygen (O₂) stream 214 at about 11,000 TPD to the gasifiers 210. The use of the oversized air separation units 212 can result in an increase in overall SNG production. The gasifiers 210 produce a slag stream 216 and a syngas stream 220. The slag stream 216 may comprise metals naturally occurring in the coke and biomass feed streams 202, 204, and added minerals to control the melting point of the slag stream 216. The slag stream 216 may be utilized as an aggregate in concrete manufacturing and/or the manufacturing of other materials.

The syngas stream 220 comprises about 35% carbon monoxide (CO), about 15% hydrogen (H₂), about 40% water (H₂O), and about 10% carbon dioxide (CO₂). The conversion of the slurry stream 208 and O₂ stream 214 into the slag stream 216 and the stream 220 is an exothermic process and as a result, a high pressure saturated steam stream 222 also is produced.

The stream 220 enters shift reactors 224 (4×30%). The shift reactors 224 are catalytic reactors that convert the stream 220 into a stream 228. Specifically, the shift reactors 224 produce more H₂ and CO₂ by reacting the H₂O with the CO. The stream 228 comprises about 15% CO, about 45% H₂, and about 40% CO₂. In certain embodiments, the shift reactors 224 include gas cooling capabilities.

The stream 228 enters acid gas removal systems 230 (2×50%). The acid gas removal systems 230 may utilize Selexol™ for hydrogen sulfide (H₂S) removal and CO₂ capture. As a result, a CO₂ stream 232 at about 22,000 TPD is produced. The CO₂ stream 232 is compressed in a compressor system 234, which includes a CO₂ refrigeration exchanger (not shown), and the resulting high pressure CO₂ stream 236 may then be utilized for enhanced oil recovery (EOR) (not shown) by pumping the CO₂ into the ground to increase the production of oil.

The acid gas removal systems 230 also produce an acid gas stream 238. The acid gas stream 238 enters sulfur recovery units 240 (3×50%) to produce a sulfur stream 242 and a recycle tail gas stream 244. The sulfur stream 242 comprises sulfur and can be sold to fertilizer plants and the like. The recycle tail gas stream 244 comprises some sulfur and is recycled back into the acid gas removal systems 230.

The acid gas removal systems 230 also produce a stream 248 comprising mainly of CO and H₂. Since the CO₂ has been removed within the acid gas removal systems 230, the stream 248 comprises about 25% CO and about 75% H₂. In certain embodiments, the stream 248 can be sold as syngas to market or consumed by other systems requiring the syngas (not shown). The syngas may be used as ammonia, methanol, or hydrogen, or be utilized in the production of power or chemicals.

The stream 248 enters methanation reactors 250 (2×50%). The methanation reactors 250 convert the stream 248 into a stream 254. The stream 254 comprises SNG at about 180 million standard cubic feet per day of gas (MMSCFD) and can be sold to market or consumed by other systems requiring the syngas. In certain alternative embodiments, a portion of the stream 254 can enter combustion turbines (not shown) to produce power to be sold to market.

In addition, the high pressure saturated steam stream 222 from the gasifiers 210 enters the methanation reactors 250. The conversion of the stream 248 into the stream 254 in the methanation reactors 250 is an exothermic reaction and as a result, the high pressure saturated steam stream 222 is converted to a high pressure superheated steam stream 258 at about 2,800 kilo pounds per hour (kpph). The high pressure superheated steam stream 258 can be utilized in a steam turbine (1×120%) (not shown) to produce power to be sold to market or consumed by other systems requiring the power.

In the exemplary embodiment of the gasification unit 200, the largest consumers of power or refrigeration needs are the air separation units 212, the acid gas removal systems 230, and the compressor system 234 for the compressing and cooling of the CO₂ stream 232.

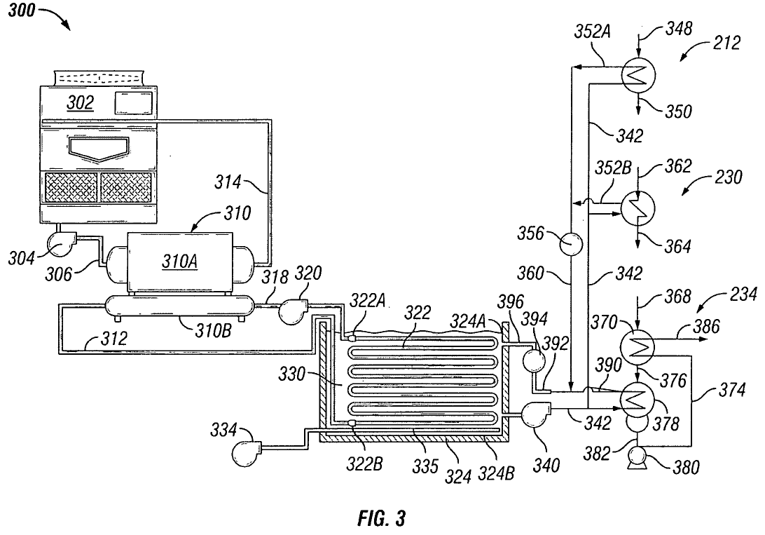

FIG. 3 illustrates an exemplary embodiment of an ice refrigeration storage system 300 for managing the power supply to the air separation unit 212, the acid gas removal system 230, and the compressor system 234 of the gasification unit 200 (FIG. 2). The ice refrigeration storage system 300 comprises a cooling tower 302 coupled to a condenser water pump 304. The condenser water pump 304 pumps a cold water stream 306 from the cooling tower 302 to a water unit 310a of a glycol chiller 310. The glycol chiller 310 is a heat exchanger that utilizes the cold water stream 306 to chill a warm glycol stream 312 that enters a glycol unit 310b of the glycol chiller 310. In certain embodiments, the warm glycol stream 312 flows at about 370 million British thermal units per hour (MMBTU/h) and is at a temperature of about 25° F. A hot water stream 314 exits the water unit 310a of the glycol chiller 310 and returns to the cooling tower 302 for further cooling. A cold glycol stream 318 exits the glycol unit 310b of the glycol chiller 310 and flows to a glycol pump 320. In certain embodiments, the cold glycol stream 318 is at a temperature of about 20° F. Although this embodiment depicts a glycol chiller 310, any type of refrigerant chiller may be used without departing from the scope and spirit of the exemplary embodiment. Thus, although glycol is used within the glycol unit 310b, any refrigerant may be used that is capable of forming ice within an ice storage unit 324, which is further discussed below.

The glycol pump 320 pumps the cold glycol stream 318 through a thermal storage coil 322 housed in an ice storage unit 324. The thermal storage coil 322 is positioned such that a first terminus 322a of the thermal storage coil 322 is located at a top 324a of the ice storage unit 324 and a second terminus 322b of the thermal storage coil 322 is located at a bottom 324b of the ice storage unit 324. The thermal storage coil 322 also loops from side to side within the ice storage unit 324 to increase the length and surface area of the thermal storage coil 322 within the ice storage unit 324. The cold glycol stream 318 is converted to the warm glycol stream 312 as it exits the ice storage unit 324. The warm glycol stream 312 is then fed back into the glycol chiller 310 and chilled for further reuse by the thermal storage coil 322. Although this embodiment depicts the first terminus 322a and the second terminus 322b at particular locations within the ice storage unit 324, the first terminus 322a and the second terminus 322b may be positioned at any location, either within or on the exterior of the ice storage unit 324 without departing from the scope and spirit of the exemplary embodiment. Further, although the thermal storage coil 322 has been depicted to be oriented in a serpentine manner, the thermal storage coil 322 may be oriented in any pattern, including, but not limited to spiral, a diagonal serpentine, a vertical serpentine, circular, and rectangular, so long as the surface area is maximized to provide proper cooling to the ice/water within the ice storage unit 324 and surrounding the thermal storage coil 322 without departing from the scope and spirit of the exemplary embodiment.

The ice storage unit 324 stores H₂O 330 as mostly solid (ice) or mostly liquid (water). As the cold glycol stream 318 is pumped through the thermal storage coil 322, at least a portion of the H₂O 330 is converted from water to ice. The looped configuration of the thermal storage coil 322 facilitates the formation of sheets of ice between the loops of the thermal storage coil 322. In certain embodiments, the H₂O 330 is at a temperature of about 32° F. In certain embodiments, the ice storage unit 324 has a width of about 55 feet, a length of about 75 feet, a height of about 35 feet, and stores about 53,000 ton-h of H₂O 330. In alternative embodiments, the ice storage unit 324 stores about 250,000 ton-h of H₂O 330. Although exemplary dimensions have been provided for the ice storage unit, the dimensions of the ice storage unit 324 can be different based on the amount of cooling required for the system and the time available for performing the cooling.

The ice refrigeration storage system 300 also comprises an air pump 334 which feeds air bubbles into the ice storage unit 324 via an air tube 335 located at the bottom of the ice storage unit 324. The air bubbles aid in preventing bridging of the ice sheets between the loops of the thermal storage coil 322 and facilitate the flow of water within the ice storage unit 324.

An ice water pump 340 pumps a chilled water stream 342 comprising H₂O 330 at about 32° F. from the ice storage unit 324 to the air separation unit 212 at 9,000 gallons per minute (GPM) during offpeak price period 110 (FIG. 1) and 13,500 GPM during peak price period 120 (FIG. 1), to the acid gas removal system 230 at 8,000 GPM, and to the CO₂ refrigeration exchanger 378 at 32,000 GPM.

The air separation unit 212 comprises an air stream 348 entering at a temperature of about 90° F. The air separation unit 212 operates at about 180 MMBTU/h during offpeak price period 110 (FIG. 1) and at about 95 MMBTU/h during peak price period 120 (FIG. 1). The air stream 348 is cooled by the chilled water stream 342 and exits the air separation unit 212 as air stream 350 at about 45° F. Chilling the air stream 348 to air stream 350 allows water in the air stream 348 to condense and increases the density of the air stream 350.

The chilled water stream 342 exits the air separation unit 212 as heated water stream 352a at 60° F. after cooling the air stream 348. The heated water stream 352a enters a high temperature chiller 356. The high temperature chiller 356 operates at about 160 MMBTU/h. The high temperature chiller 356 chills the heated water stream 352a to about 45° F. and the heated water stream 352a exits the high temperature chiller 356 as chilled water stream 360. In certain embodiments, the high temperature chiller 356 operates only during the offpeak price period 110 (FIG. 1). In alternative embodiments, the high temperature chiller 356 operates during offpeak price period 110 (FIG. 1) and mid-peak price period 130 (FIG. 1). In alternative embodiments, the high temperature chiller 356 operates at all times.

The acid gas removal system 230 comprises a Selexol™ stream 362 entering at a temperature of about 90° F. The acid gas removal system 230 operates at about 100 MMBTU/h. The Selexol™ stream 362 is cooled by the chilled water stream 342 and exits the acid gas removal system 230 as chilled Selexol™ stream 364 at about 40° F. Although specific temperatures have been provided for the Selexol™ streams 362, 364, alternative embodiments may have different temperatures for the Selexol™ streams 362, 364 without departing from the scope and spirit of the exemplary embodiment.

The chilled water stream 342 exits the acid gas removal system 230 as heated water stream 352b at about 60° F. after cooling the Selexol™ stream 362. The heated water stream 352b enters the high temperature chiller 356. The high temperature chiller 356 chills the heated water stream 352b to about 45° F. and the heated water stream 352b exits the high temperature chiller 356 as chilled water stream 360. The operation of the high temperature chiller 356 has been previously described above.

The compressor system 234 comprises a dry CO₂ stream 368 entering a first heat exchanger 370 and exiting as a cooled CO₂ stream 376. The dry CO₂ stream 368 is at about 640 psig, and is cooled from a temperature of about 90° F. to about 60° F. by a liquid CO₂ stream 374 at about 2200 psig and about 50° F. The cooled CO₂ stream 376 enters the CO₂ refrigeration exchanger 378 and exits as cooled CO₂ stream 382. The cooled CO₂ stream 376 is further cooled to about 50° F. by the chilled water stream 342. The CO₂ refrigeration exchanger 378 operates at about 170 MMBTU/h. A pump 380 compresses and pumps the cooled CO₂ stream 382, which is now the liquid CO₂ stream 374. The liquid CO₂ stream 374 is utilized in the first heat exchanger 370, as previously discussed, and exits the first heat exchanger 370 as liquid CO₂ stream 386 at about 2200 psig and about 80° F.

The chilled water stream 342 exits the CO₂ refrigeration exchanger 378 as water stream 390 having a temperature of about 45° F. The water stream 390 is combined with chilled water stream 360 to form water stream 392. The water stream 392 enters a low temperature chiller 394. The low temperature chiller 394 operates at about 300 MMBTU/h. The water stream 392 is further cooled to produce a water stream 396 having a temperature of about 36° F. In certain embodiments, the temperature of water stream 396 may range from about 33° F. to about 48° F. The water stream 396 is then fed into the ice storage unit 324 and mixed with the H₂O 330. In certain embodiments, the low temperature chiller 394 operates only during the offpeak price period 110 (FIG. 1). In alternative embodiments, the low temperature chiller 394 operates during offpeak price period 110 (FIG. 1) and mid-peak price period 130 (FIG. 1). In alternative embodiments, the low temperature chiller 394 operates at all times.

Generally, the ice refrigeration storage system 300 is designed such that the glycol chiller 310, the high temperature chiller 356, and the low temperature chiller 394 operate during offpeak price period 110 (FIG. 1). During the offpeak price period 110 (FIG. 1), the export of power is minimized and refrigeration (ice and liquid O₂) can be stored. During the mid-peak price period 130 (FIG. 1), the glycol chiller 310 is not in operation, but the high temperature chiller 356 and the low temperature chiller 394 are in operation. During the peak price period 120 (FIG. 1), the glycol chiller 310, the high temperature chiller 356, and the low temperature chiller 394 are not in operation. The stored refrigeration can be utilized during the peak price period 120 (FIG. 1) while export of power can be maximized. In addition, power can be imported and utilized during the offpeak price period 110 (FIG. 1) at a lower price than during the peak price period 120. Therefore, significant power revenue can be generated by the gasification unit 200 from peak price period power sales vs. baseload operation power sales.

To facilitate a better understanding of the present invention, the following hypothetical example of certain aspects of certain embodiments is given. In no way should the following example be read to limit, or define, the scope of the invention.

### EXAMPLE

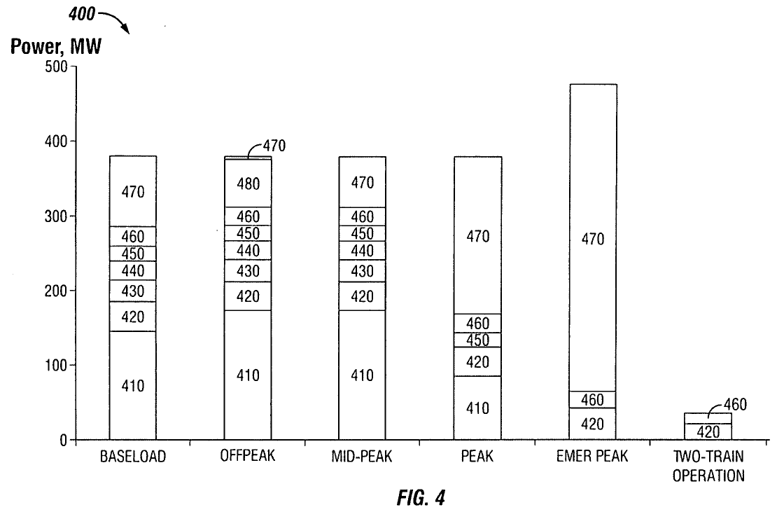

FIG. 4 is a graph 400 comparing the generated power usage of existing baseload operations with the generated power usage of the load management system utilizing the ice refrigeration system of FIG. 3 in accordance with an exemplary embodiment. During baseload operations, generated power is constantly supplied as follows: about 145 megawatts (MW) to air separation units 410, about 40 MW for CO₂ compression 420, about 30 MW for CO₂ refrigeration 430, about 25 MW for refrigeration of the solvent used in acid gas removal systems 440, about 20 MW for grinding of coal/coke 450, about 25 MW for miscellaneous use 460, and about 95 MW for export 470. Thus, the total generated power during baseload operations is about 380 MW.

The refrigeration storage system of the present invention operates based on the price period. The offpeak price period is about 2825 hours/year (h/y), the mid-peak price period is about 2825 h/y, the peak price period is about 3000 h/y, and the emergency peak period is about 10 h/y. In addition, a two-train operation shutdown is conducted during about 100 h/y. During the two-train operation shutdown, power is not generated and only power for CO₂ compression 420 and miscellaneous use 460 is imported and consumed.

During the offpeak price period, generated power is supplied as follows: about 173 MW to air separation units 410, about 40 MW for CO₂ compression 420, about 30 MW for CO₂ refrigeration 430, about 25 MW for refrigeration of the solvent used in acid gas removal systems 440, about 20 MW for grinding of coal/coke 450, about 25 MW for miscellaneous use 460, about 65 MW for ice storage 480, and about 2 MW for export 470. Thus, the total generated power during the offpeak price period operation is about 380 MW, which is similar to the total generated power during baseload operations.

During the mid-peak price period, generated power is supplied as follows: about 173 MW to air separation units 410, about 40 MW for CO₂ compression 420, about 30 MW for CO₂ refrigeration 430, about 25 MW for refrigeration of the solvent used in acid gas removal systems 440, about 20 MW for grinding of coal/coke 450, about 25 MW for miscellaneous use 460, and about 67 MW for export 470. As shown, the generated power typically used for the ice storage 480 during the offpeak price period is now exported during the mid-peak price period. The total generated power during the mid-peak price period operation is about 380 MW, which is similar to the total generated power during baseload operations.

During the peak price period, generated power is supplied as follows: about 84 MW to air separation units 410, about 40 MW for CO₂ compression 420, about 20 MW for grinding of coal/coke 450, about 25 MW for miscellaneous use 460, and about 211 MW for export 470. As shown, the generated power typically used for CO₂ refrigeration 430, refrigeration of the solvent used in acid gas removal systems 440, and some of the generated power used for the air separation units 410 during the mid-peak price period is now exported during the peak price period. Instead, power for CO₂ refrigeration 430, refrigeration of the solvent used in acid gas removal systems 440, and some of the power for the air separation units 410 are provided by ice storage 480. Some of the non-essential systems may be turned off so as to increase the export of power during the peak price period. The total generated power during the peak price period operation is about 380 MW, which is similar to the total generated power during baseload operations.

During the emergency peak period, generated power is supplied as follows: about 40 MW for CO₂ compression 420, about 25 MW for miscellaneous use 460, and about 315 MW for export 470. As shown, the generated power typically used for the air separation units 410 and the grinding of coal/coke 450 during the peak price period is now exported during the emergency peak period. Additionally, about 120 MW additional generated power is produced during this emergency peak period. All of the non-essential systems are turned off so as to increase the export of power during the emergency peak period. The total generated power during the emergency peak period operation is about 500 MW, which is about 120 MW more than the total generated power during baseload operations.

During the two-train operation shutdown period, 35 MW of power is imported and distributed as follows: 20 MW for CO₂ compression 420 and 15 MW for miscellaneous use 460.

To achieve the above results, 3×40% air separation units 410 with 12 hour liquid O₂ storage, 16 hour offpeak ice production for CO₂ and refrigeration of the solvent used in acid gas removal systems, and 50 MW additional steam turbine and boiler capacity are required.

From FIG. 4, it can be seen that the yearly export of power is maximized during the peak price period and minimized during the offpeak price period.

Therefore, the invention is well adapted to attain the ends and advantages mentioned as well as those that are inherent therein. The particular embodiments disclosed above are illustrative only, as the invention may be modified and practiced in different but equivalent manners apparent to those having ordinary skill in the art and having the benefit of the teachings herein. While numerous changes may be made by those having ordinary skill in the art, such changes are encompassed within the spirit of this invention as defined by the appended claims. For example, while the use of a glycol chiller is discussed, any solvent heat exchange medium can be used to chill water from the cooling tower. Additionally, solvents such as Rectosol™ or amine solvents, e.g. methyl diethanol amine (MDEA), can be used for acid gas removal. Furthermore, no limitations are intended to the details of construction or design herein shown, other than as described in the claims below. It is therefore evident that the particular illustrative embodiments disclosed herein may be altered or modified and all such variations are considered within the scope and spirit of the claimed invention. The terms in the claims have their plain, ordinary meaning unless otherwise explicitly and clearly defined by the patentee.

What is claimed is:

1. A gasification facility, comprising:
a gasification unit, the gasification unit having at least one selected from the group consisting of gasifiers, air separation units, acid gas removal systems, and CO₂ refrigeration systems; and
a refrigeration storage system for supplying a cooled first medium to the gasification unit.

2. The gasification facility of claim 1, wherein the gasification unit comprises three air separation units at 40% capacity.

3. The gasification facility of claim 1, wherein the air separation units comprise liquid oxygen storage.

4. The gasification facility of claim 1, wherein the gasification unit comprises four gasifiers at 30% capacity.

5. The gasification facility of claim 1, wherein the refrigeration storage system comprises a housing, wherein the housing comprises a first medium and a second medium for cooling the first medium to produce the cooled first medium and a third medium.

6. The gasification facility of claim 5, wherein the first medium comprises water, the cooled first medium comprises chilled water, and the third medium comprises ice.

7. The gasification facility of claim 5, wherein the second medium is a heat transfer medium.

8. The gasification facility of claim 7, wherein the heat transfer medium comprises glycol.

9. The gasification facility of claim 5, wherein the refrigeration storage system further comprises a pump, wherein the pump pumps the cooled first medium from the housing to the gasification unit, wherein the cooled first medium is formed from a combination of cooling the first medium and melting of the third medium.

10. The gasification facility of claim 5, wherein the housing further comprises a pipe serpentining within the housing, wherein the second medium flows through the pipe.

11. The gasification facility of claim 10, wherein the third medium comprises ice, and wherein the ice is formed in sheets between portions of the pipe.

12. The gasification facility of claim 10, wherein the refrigeration storage system further comprises:
a cooling tower for cooling water;
a heat exchanger having a water side comprising water and a refrigerant side comprising the second medium, wherein heat transfer occurs between the water and the second medium, the water being heated while the second medium being cooled within the heat exchanger, and wherein the housing is positioned downstream of the heat exchanger;
a condenser water pump for recirculating water from the cooling tower, through the water side of the heat exchanger, and back to the cooling tower; and
a refrigerant pump for recirculating the second medium from the heat exchanger, through the pipe within the housing, and back to the heat exchanger.

13. The gasification facility of claim 12, wherein the refrigeration storage system further comprises an air pump coupled to the bottom of the housing via an air tube, the air pump producing bubbles at the bottom of the housing to prevent the third medium from forming on the pipe.

14. The gasification facility of claim 1, wherein the gasification facility generates power.

15. A method of managing a power supply for a gasification facility comprising a gasification unit having at least one selected from the group consisting of gasifiers, air separation units, acid gas removal systems, and a CO₂ refrigeration systems, the method comprising:
using a refrigeration storage system to produce at least most of a chilled medium during an offpeak price period;
using the chilled medium for cooling to the at least one of an air separation unit, an acid gas removal system, and a CO₂ refrigeration.

16. The method of claim 15, wherein the chilled medium comprises ice.

17. The method of claim 15, wherein the offpeak price period occurs during a time when a market price of power is lowest.

18. The method of claim 15, wherein the offpeak price period occurs during a time when demand for power is lowest.

19. The method of claim 15, wherein the air separation units comprise liquid oxygen storage.

20. The method of claim 15, wherein the refrigeration storage system comprises a refrigeration storage unit, wherein the refrigeration storage unit comprises a first medium and a second medium for cooling the first medium to produce the cooled first medium and the chilled medium.

21. The method of claim 20, wherein the first medium comprises water, the cooled first medium comprises chilled water, and the chilled medium comprises ice.

22. The method of claim 20, wherein the second medium comprises a heat transfer medium.

23. The method of claim 22, wherein the heat transfer medium comprises glycol.

24. The method of claim 20, wherein the refrigeration storage system further comprises a pump, wherein the pump pumps the cooled first medium from the refrigeration storage unit to the gasification unit, wherein the cooled first medium is formed from a combination of cooling the first medium and melting of the chilled medium.

25. The method of claim 20, wherein the refrigeration storage unit further comprises a pipe serpentining within the refrigeration storage unit, wherein the second medium flows through the pipe.

26. The method of claim 25, wherein the chilled medium comprises ice, and wherein the ice is formed in sheets between portions of the pipe.

27. The method of claim 25, wherein the refrigeration storage system further comprises:
a cooling tower for cooling water;
a heat exchanger having a water side comprising water and a refrigerant side comprising the second medium, wherein heat transfer occurs between the water and the second medium, the water being heated while the second medium being cooled within the heat exchanger, and wherein the refrigeration storage unit is positioned downstream of the heat exchanger;
a condenser water pump for recirculating water from the cooling tower, through the water side of the heat exchanger, and back to the cooling tower; and
a refrigerant pump for recirculating the second medium from the heat exchanger, through the pipe within the refrigeration storage unit, and back to the heat exchanger.

28. The method of claim 27, wherein the refrigeration storage system further comprises an air pump coupled to the bottom of the refrigeration storage unit via an air tube, the air pump producing bubbles at the bottom of the refrigeration storage unit.

29. The method of claim 15, further comprising the step of:
generating power from the gasification facility.

30. A method for load management of a gasification facility having a refrigeration storage system, comprising:
generating power for export and use within the gasification facility; and
utilizing a portion of the power to form a chilled medium within the refrigeration storage system during an offpeak period, the chilled medium providing power to a portion of the Gasification facility during at least a peak period.

31. The method of claim 30, further comprising the step of:
importing and utilizing power during the offpeak period.

32. The method of claim 30, wherein the portion of the gasification facility includes at least one selected from the group consisting of gasifiers, air separation units, acid gas removal systems, and CO₂ refrigeration systems.

33. The method of claim 30, wherein the portion of the power to form a chilled medium within the refrigeration storage system during an offpeak period is exported during a mid-peak period.

34. The method of claim 30, wherein the portion of the power to form a chilled medium within the refrigeration storage system during an offpeak period is exported during the peak period and wherein at least a portion of the generated power used for at least one selected from the group consisting of gasifiers, air separation units, acid gas removal systems, and CO₂ refrigeration systems within the gasification facility during the offpeak period is exported during the peak period.
